(19) United States
(12) Patent Application Publication
(10) Pub. No.: US 2009/0320659 A1
(43) Pub. Date: Dec. 31, 2009

(54) Method and apparatus for making storage container from plastic bottle

(76) Inventor: Sean Lalloway, Danbury, CT (US)

Correspondence Address: James W. Badie, Esq.;Law Offices of James W. Badie, Suite 3300, 521 Fifth Avenue, New York, NY, 10175-3399, US

(21) Appl. No.: 12/462,001

(22) Filed: Jul. 28, 2009

Related U.S. Application Data
(62) Division of application No. 11/599,141, filed on Nov. 14, 2006.

(51) Int. Cl. B26D 1/00; B26D 7/00; B26D 7/10

(52) U.S. Cl. 83/13; 83/651.1; 83/171

(57) ABSTRACT

An apparatus and method are disclosed for cutting a cylindrical plastic bottle into two sections, providing the open end of one section with an externally threaded collar and the open end of the other section with an internally threaded collar, and threadedly engaging the two sections into a storage container.

### RELATED APPLICATION

This application is a divisional application based on pending application Ser. No. 11/599,141 filed Nov. 14, 2006.

### FIELD OF THE INVENTION

The present invention relates generally to a method and apparatus for making storage containers, and is particularly related to making a storage container from cylindrical plastic bottle, and more specifically from recyclable plastic bottles. The invention reforms a plastic bottle into a plastic container for storage of various objects such as nails, screws, etc.

### BACKGROUND OF THE INVENTION

Plastic bottles are frequently discarded after their contents have been used, or they are, sometimes, recycled for treatment and re-use by refilling the bottles. Other non-plastic bottles, e.g., glass bottles, also are generally either discarded or treated for re-use.

U.S. Pat. No. 3,699,829 issued Oct. 24, 1972 to Ephren J. Gelfman describes a method and apparatus for cutting hollow cylindrical glass bottles, removing the upper neck portion and making the bottom portion into a useful container. In the method of the Gelfman patent, a glass bottle is rotated about its axis which is supported by a support structure having two spaced support rollers. One of the support rollers has a cutting edge which engages the periphery of the support structure during rotation of the bottle for forming a circular score line. Heat is applied to the bottle along the score line, and the bottle is then rapidly cooled by quenching with ice to cause a break along the score line and the bottle is thus cut into an upper portion and a lower portion, and the edges at the break line are smoothed by sanding with an abrasive material. The bottom cut portion is in the form of an open container which can be used for storage of various objects.

Another device for cutting hollow cylindrical glass objects such as bottles is described in U.S. Pat. No. 3,805,647 issued Apr. 28, 1974 to Yale A. Blanc. By the method and apparatus described by Blanc, wine bottles, beer bottles, cooking oil bottles, syrup bottles and jugs can be cut and converted to vases, goblets and candy dishes.

The aforementioned patents and, so far as is known, other prior art patents, disclose method and apparatus for cutting glass bottles to provide a bottom portion which serve as open container. The upper cut portion is usually discarded thus adding to waste and inefficiency.

It is therefore an object of the present invention to provide a method and apparatus for cutting a plastic cylindrical bottle into an upper portion and a bottom portion and reforming the two cut portions into a closed storage container.

It is a further object of this invention, to provide such method and apparatus for recycled cylindrical plastic bottles thus avoiding waste and littering caused by discarding portions of the bottles.

It is also an object of the present invention to provide such reformed plastic bottles for storage of various small size objects such as screws, nails and the like.

The foregoing and other objects of this invention will be further comprehended from the following detailed description and the accompanying drawings.

### SUMMARY OF THE INVENTION

In accordance with the present invention, an apparatus and method are provided for forming storage containers from used plastic bottles. The apparatus comprises a solid support member such as a wooden block or the like which has an upper flat surface, a bottom flat surface, front and rear sides, and left and right sides. The upper surface has a transverse groove extending from one end of the upper surface to the other end of the upper surface, a plurality of vertical spaced apart parallel grooves on one side of said transverse groove and a plurality of horizontal spaced apart parallel grooves on the other side of said transverse groove. One support flap is frictionally engaged in one of said vertical spaced apart parallel grooves and another flap support member is frictionally engaged in another one of said spaced apart vertical parallel grooves for securely positioning a portion, i.e., lower portion of the plastic bottle, and a support flap member is frictionally engaged in one of said horizontal grooves for securely positioning the other portion, i.e., the neck end of the bottle. An electrical wire is tautly held above the neck portion of said bottle which is connected to an electrical power source. The electrical wire is secured to a handle which can be manipulated to raise and lower the heated electrical wire for cutting through the plastic bottle in two portions.

Each of the cut portions of the bottle is provided with a threaded collar, one with an internally threaded collar, and the other with an externally threaded collar adapted to be inter-engaged to form a storage container. Prior to inter-engaging the two bottle portions, the lower portion may be filled with various objects such as screws, nails, etc. The neck portion is capped with a closure member hanging a hook for hanging the storage container from a support rail.

### BRIEF DESCRIPTION OF THE DRAWINGS

In the drawings, like reference numerals are employed to designate like parts.

FIG. 1 is a partly perspective view of a block used to support the plastic bottle in position and showing a cutting wire and its associated handle;

FIG. 2 is a side, partly perspective view of the block of FIG. 1 showing the side which can be connected to an outer electric source;

FIG. 3 is a top view of the block of FIG. 1 with side support flaps inserted through slots for securing a plastic bottle;

FIG. 4 is a top, partly perspective view of the block of FIG. 1 with a plastic bottle secured in position by the side flap and front flap with neck slot, and showing the cutting wire assembly in pre-cut position;

FIG. 5 is a view of the neck-supporting flap looking in the direction of the arrow A in FIG. 4;

FIG. 6 is a side view of a plastic bottle which has been cut into an upper portion and a lower portion adapted to be re-engaged to form a storage container, and

FIG. 7 is a side view of several plastic bottles reformed into respective storage containers hanging from a rail during storage.

### DETAILED DESCRIPTION OF THE INVENTION

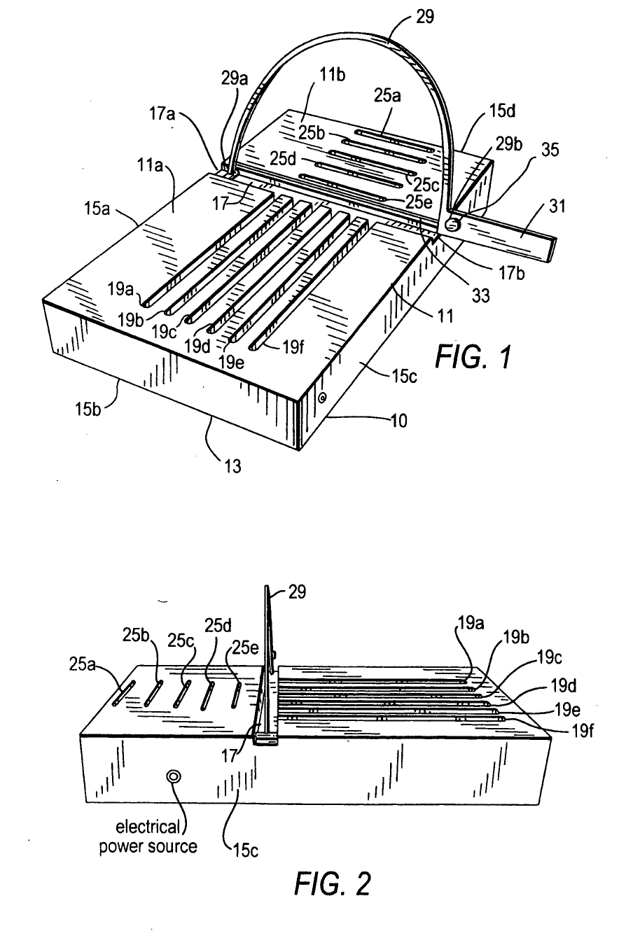

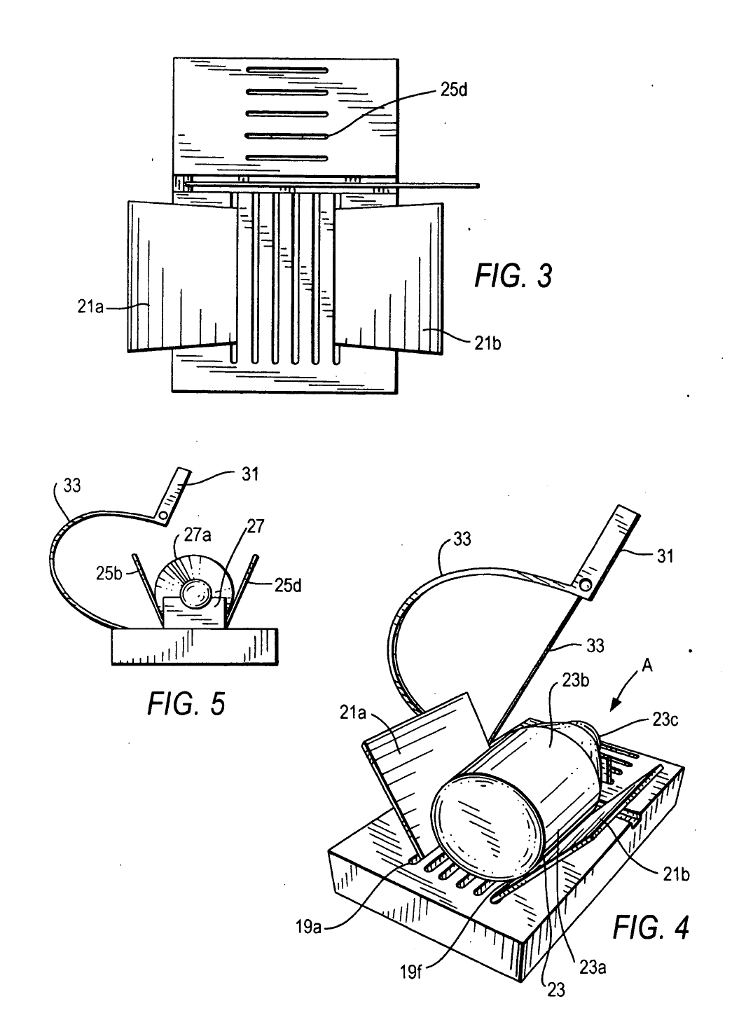

Referring to the drawings, there in shown in FIG. 1 a supporting member 10 (e.g., a block) which may be plastic, wood or any other suitable material defined by an upper relatively flat surface 11, a bottom flat surface 13 and sides 15a, 15b, 15c and 15d. The top surface 11 comprises a generally longer section 11a and a generally short section 11b which are separated by a transverse channel (groove) 17 spanning from one end 17a to the other end 17b at the sides 15a, 15c of upper surface 11. A plurality of horizontally disposed parallel grooves 19a, 19b, 19c, 19d, 19e and 19f are formed on the surface 1a of the upper surface 11 of the support block 10. These grooves are preferably spaced apart at equal distances and are deep enough for frictionally fitting support flaps 21a, 21b into two grooves in order to secure the lower portion 23a of the plastic bottle 23 in position as shown in FIGS. 3 and 4.

The shorter section 11b of the upper surface 11 is provided with a plurality of transversely disposed parallel grooves 25a, 25b, 25c, 25d and 25e and a neck-holder supporting flap 27 is frictionally inserted into one of these grooves, depending on the size of the plastic bottle, in order to secure the upper portion 23b of the bottle 23. The upper section of the support flap 27 is cut into a half-moon shaped cut-out 27a (see FIG. 5) for supporting the neck 23c of portion 23b of the bottle in secure position as shown in FIG. 4.

The number and sizes of the grooves in both sections of the upper surface of the supporting block, as well as the size and thickness of the supporting flaps may vary depending on the size of the plastic bottle to be cut, and the supporting flaps themselves may be rigid, plastic or stiff cardboard. Such variations are within the knowledge of those skilled in the art and are evident from the present description.

As shown in FIGS. 1 and 4, the bottle cutting means comprises an insulated arched member 29 which is hollow through which an electrical wire (not visible) extends from one end of the arched member 29a to the opposite end of the arched member 29b. The arched member is hingedly fixed at the end 29b and has a handle 31, with a cutting wire 33 tautly fixed between the end 17b of handle 31 and the end 17a. The cutting wire 33 may be an extension of the insulated wire in the hollow arched member 29 or it may be a separate wire electrically connected to the insulated wire. The wires are in electrical contact with an external electrical power supply (not shown) which is activated by the push button 25 which energizes the insulated wire and heats up the cutting wire to the temperature desired to cut the bottle.

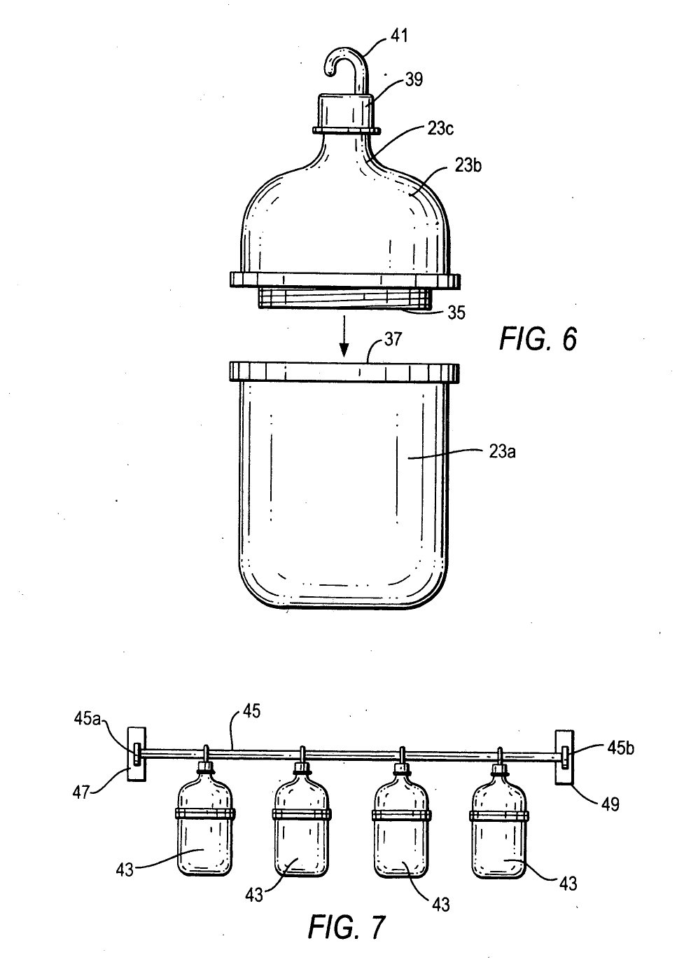

In order to cut a plastic bottle, and again referring to the drawings, particularly FIGS. 1 3 and 5, the plastic bottle 23 is placed on the upper surface 11 of the supporting block, and is firmly secured in position by the supporting flaps 21a and 21b such that the lower portion 23a rests securely on the lower section of the upper surface and the neck portion 23a of the bottle is firmly retained by the neck holder supporting flap 27. The wire 33 is then heated by electric current provided from the outside electrical source and when the wire is sufficiently hot, the handle 31 is gripped by the handle lifted upward above the bottle 23 (see FIG. 4) and then lowered to slice through the bottle, thus cutting it into two portions, the lower portion 23a and the upper portion 23b and the two portions are then removed from the supporting block 10. Referring to FIG. 6, the two bottle portions may be reconnected, i.e., joined together, by providing inter-engaging suitable collars around the open ends of the severed portions, one collar being an inwardly threaded collar 37 (threads not seen) formed in the lower portion 23a and the other being an externally threaded collar 35 adapted to engage the inwardly threaded collar 35 to form a closed container, i.e., the reformed bottle. Since the purpose of the invention is to reform a plastic bottle into a storage container, the lower bottle portion may be filled with nails, screws and other desired paraphernalia prior to threading the top portion into the lower portion. As shown in FIG. 6, the neck portion 23c of the upper portion of the plastic bottle is provided with a closure cap 39 and a hook member 41 of the types and variety well known in the art.

The reformed plastic bottles which serve as storage containers may be stored in a garage or some other storage facility wherein several of these storage containers 43 may hang in row to form a railing 45 attached at its ends 45a, 45b to opposed walls 47, 49.

1. Apparatus for cutting a cylindrical plastic bottle having a neck portion, comprising:
(a) a solid support member defined by a relatively flat upper surface, a generally flat lower surface, front side, rear side, left side and right side,
(b) said flat upper surface having a rear section having a plurality of spaced apart parallel vertical grooves, and a front section having a plurality of spaced apart parallel horizontal grooves,
(c) a pair of support flap members each frictionally engaged in a vertical groove each side of the plastic bottle for securing the rear portion of the plastic bottle, and support flap members frictionally engaged in one of said horizontal grooves for securing the front portion of said bottle,
(d) electrical wire tautly secured across said upper surface, over said bottle and connected to an outside electrical power source, and
(e) means for raising and lowering said electrical wire such that said electrical wire is heated by passage of electric current for cutting said bottle into two portions.

2. Apparatus as in claim 1 wherein said support flap member securing the front portion of said bottle has a cut portion adapted to secure the neck portion of said bottle.

3. Apparatus as in claim 1 wherein said upper surface has a transverse groove extending from one side of said solid member to the other side of said solid member, and said neck portion of said bottle is positioned above the groove.

4. Apparatus as in claim 2 wherein said upper surface has a transverse groove extending from one side of said solid member to the other side of said solid member, and said neck portion of said bottle is positioned above said groove.

5. A method of forming a storage container from used plastic bottle, which method comprises:
(a) securing said bottle on a relatively flat surface of a support member, said support member having a transverse with the lower portion of said bottle positioned on one side of said groove and the other portion of said bottle positioned on the other side of said groove;
(b) securely positioning a cutting wire above said bottle and said transverse groove;
(c) means for raising or lowering said cutting wire above said transverse groove;
(d) pasting electric current through said cutting wire to a temperature suitable for cutting said bottle;
(e) cutting said bottle by said heated electrical wire whereby said bottle is cut in two portions;
(f) providing one of said bottle portions with an externally threaded collar and the other of said bottle portion with an internally thread portions, and
(g) connecting said two bottle portions by threadedly engaging said two threaded collar portions to form a storage container.
